(19) United States
(12) Patent Application Publication
(10) Pub. No.: US 2009/0200496 A1
(43) Pub. Date: Aug. 13, 2009

(54) Headlamp system including HID and IR illuminators

(76) Inventors: Mark R. Barie, Glenshaw, PA (US); James M. Helms, Mars, PA (US)

Correspondence Address: KAREN TANG-WAI SODINI, 216 horseshoe drive, MARS, PA, 16046, US

(21) Appl. No.: 12/322,478

(22) Filed: Feb. 3, 2009

Related U.S. Application Data
(60) Provisional application No. 61/023,622, filed on Feb. 13, 2008.

(51) Int. Cl. B60Q 1/04; F21S 8/10

(52) U.S. Cl. 250/495.1; 362/545

(57) ABSTRACT

A headlamp system providing both visible and IR illumination, provided in the same housing and using the same wiring harness as a headlamp system currently in use by the US Military, but instead of utilizing incandescent bulb technology as does the headlamp system currently in use, the headlamp system provided herewith utilizes HID lighting for visible light illumination, LEDs for blackout driving and marker lights, and an array of IR LEDs for IR illumination.

### CROSS REFERENCE TO RELATED APPLICATIONS

Reference is made to and priority claimed from U.S. provisional application Ser. No. 61/023,622, filed on Feb. 13, 2008.

### TECHNICAL FIELD

The present invention pertains to the field of illumination and more particularly to headlamps for vehicles and especially for military vehicles.

### BACKGROUND OF THE INVENTION

The MMPV (Medium Mine Protected Vehicle), as well as other military vehicles, currently use a headlamp system specified in MIL-DTL-14465E (12 Aug. 1998), attached hereto, called a vehicular composite light assembly, shown in FIG. 1, including a first incandescent bulb lamp 16 providing a high beam and a low beam, and a second incandescent bulb lamp 17 also providing a high beam and a low beam, but covered by a filter so as to pass only infrared light. An operator switches from visible to infrared illumination, and thus engages one or the other of the bulbs, and then selects high beam or low beam, as needed. The headlamp system can be provided as a quick detachable or as a bolt-down model. (MIL-DTL-14465E indicates it is a specification for tracked vehicles, but the specification is also for headlamp systems used in non-tracked vehicles also.)

For each headlamp system (the right or left) according to the prior art, MIL-DTL-14465E calls for sealed-beam lamps conforming to MS18003-411, two-filament type, for high and low-beam operation, a clear lens per drawing 7962266, a filter lens for passing substantially only infrared illumination, conforming to 7962265, thus providing the first incandescent bulb lamp 16 and the second incandescent bulb lamp 17. The prior art headlamp system also includes an incandescent blackout marker light 15 serving as a “position marker” emitting white light through two Y-shaped openings in an otherwise opaque filter lens, and an incandescent blackout driving light 14, per an applicable drawing or military standard, covered by a hood 14a to conceal the light from over-flying aircraft. MIL-DTL-14465E also prescribes that electrical cable shall conform to MIL-C-13486 (stranded tinned copper conductor, rubber insulating core, inner glass braid, black neoprene jacket).

Incandescent bulbs are inefficient, and the illumination provided by such bulbs, in the visible and also in the infrared, is significantly less than what can be provided by more recently developed lighting technology. High intensity discharge (HID) and light emitting diode (LED) technology provide greater luminosity while consuming less power than standard incandescent lamps.

An HID lamp consumes less power than an incandescent lamp and has a luminous intensity even greater than a halogen lamp, approximately 200,000 cd (candela). HID lamps work by producing an electric arc through a gas, and in the case of automotive applications, typically xenon gas. The color temperature of an HID light is in the range of 5000 K, similar to daylight. The average lifespan of an HID bulb is 2000 hours, roughly 5 times longer than a standard incandescent lamp.

Incandescent bulbs are inefficient infrared (IR) light sources because the illumination provided by such bulbs is significantly less than what can be provided by light-emitting diode (LED) technology. One problem with LED sources, however, is that excessive heat generated by the LED chip inside the light housing must be effectively dissipated to avoid damaging the headlight components.

It would be advantageous to have a headlamp system using more recent lighting technology, but that is fully interchangeable with the existing headlamp, using the same wiring harness, control signals, and housing as the existing headlamp.

### SUMMARY

The invention provides a headlamp system that meets the requirements of MIL-DTL-14465E except that in place of the sealed-beam lamps and the clear lens and filter lens therefor, two high intensity discharge (HID) lights are included, one for high beam and one for low beam, and an infrared illuminator is included using an array of infrared (IR) light emitting diodes (LEDs) having a spectrum centered at either 880 nm or 940 nm, depending on the application. IR LEDs are used as a light source for the blackout driving and marker lights. The headlamp system provided by the invention uses the same housing as the headlamp system of MIL-DTL-14465E, and also the same electrical cables, so that both the mechanical and electrical interfaces are the same as for the current headlamp system.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a perspective view of a headlamp system according to the prior art.

FIG. 2 is a front view of a headlamp system according to the invention.

FIG. 3 is a perspective view of a headlamp system according to the invention.

FIG. 4 is a perspective view of an opened headlamp system according to the invention, showing a main printed circuit board and a metal plate positioned over two ballasts.

FIG. 5 is a perspective drawing of an opened headlamp system according to the invention, showing ballasts for the HID lights included in the headlamp system.

FIG. 6 is a front view of the IR illuminator with the cover off, showing the LED arrangement.

FIG. 7 is a front view of the IR illuminator cover.

FIG. 8 is a front view of another embodiment of the IR illuminator with the cover off, showing an LED arrangement and optional Fresnel lenses.

FIG. 9 is a wiring schematic for a headlamp system according to the invention.

### DRAWINGS LIST OF REFERENCE NUMERALS

The following is a list of reference labels used in the drawings to label components of different embodiments of the invention, and the names of the indicated components.
11 prior art headlamp
12 headlamp according to the invention
12a back component of the headlamp housing
12b front component of the headlamp housing
12c cut out area of interior back component of the headlamp housing
12d supports for ballasts and printed circuit board (part of back component of the headlamp housing)
14 blackout driving light
14a blackout driving light hood
15 blackout marker light
16 incandescent bulb lamp
17 IR pass filtered incandescent bulb lamp
18a low beam HID light
18b high beam HID light
18c main printed circuit board
18d ballast
18e ballast
18f metal plate with holes for wiring
19 IR illuminator
19a low beam IR LED-lens unit
19b high beam IR LED-lens unit
19c cover
19e IR illuminator housing
19f Fresnel lens
19g IR LED (with integrated lens)
20 base
61 control panel
62 power supply

### DETAILED DESCRIPTION

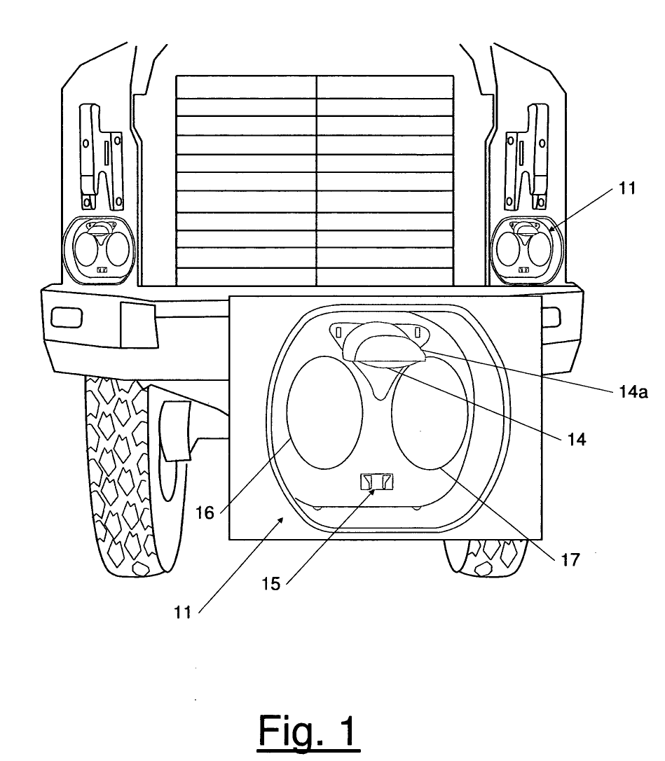

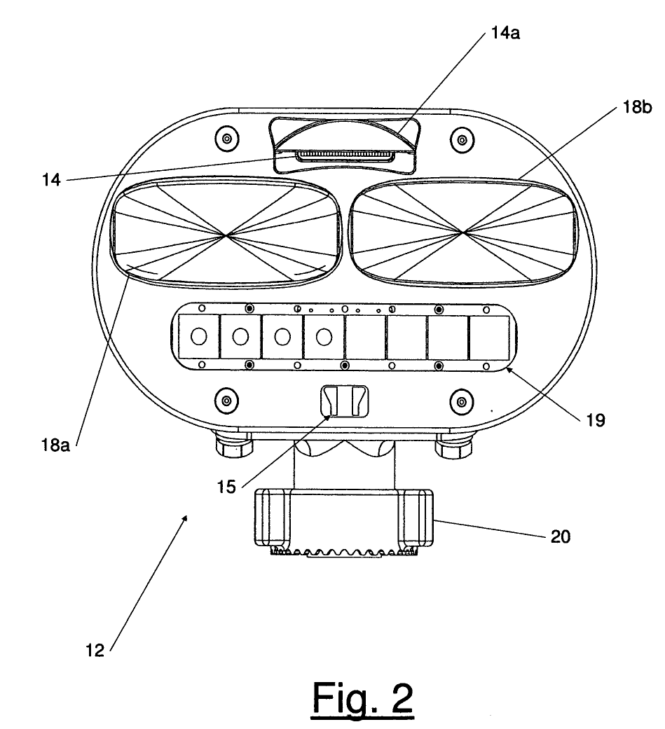

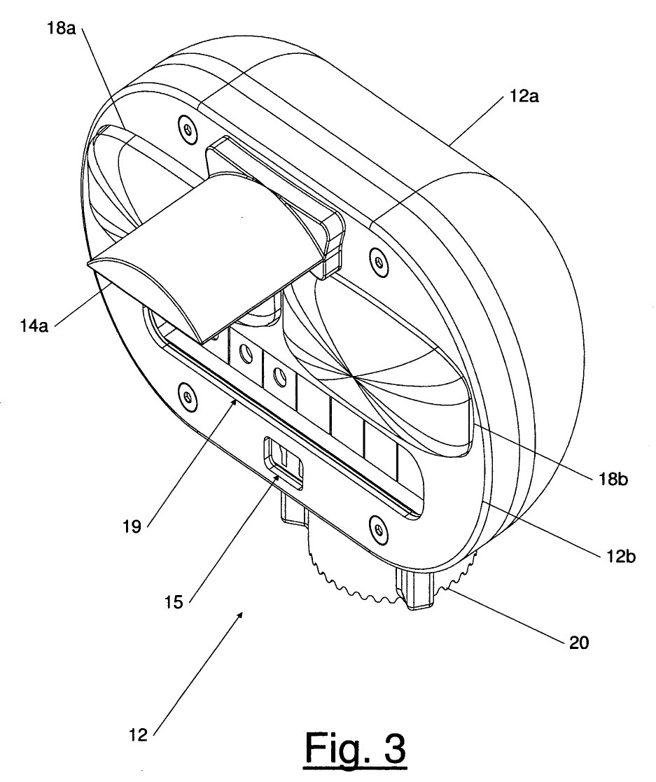

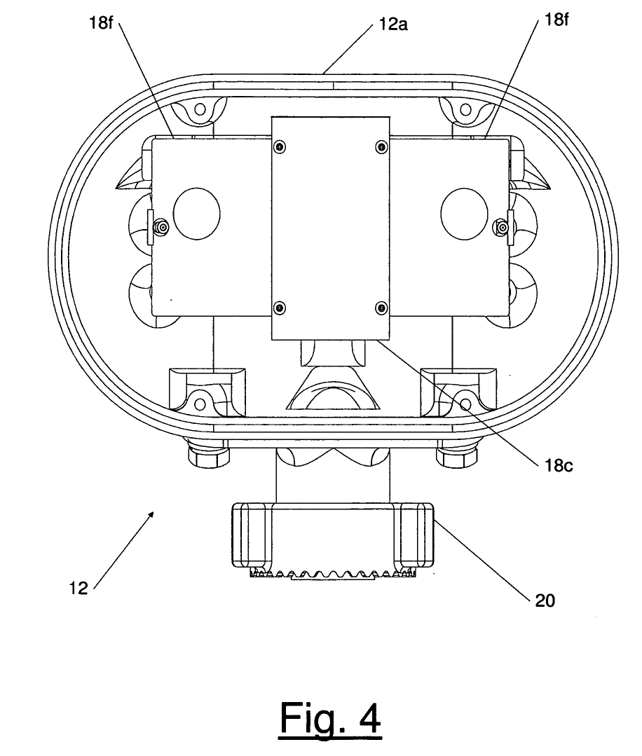

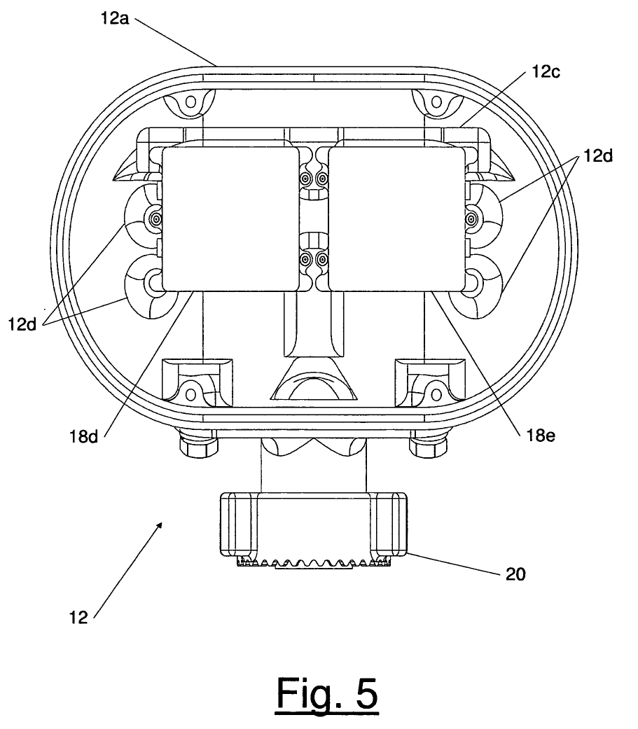

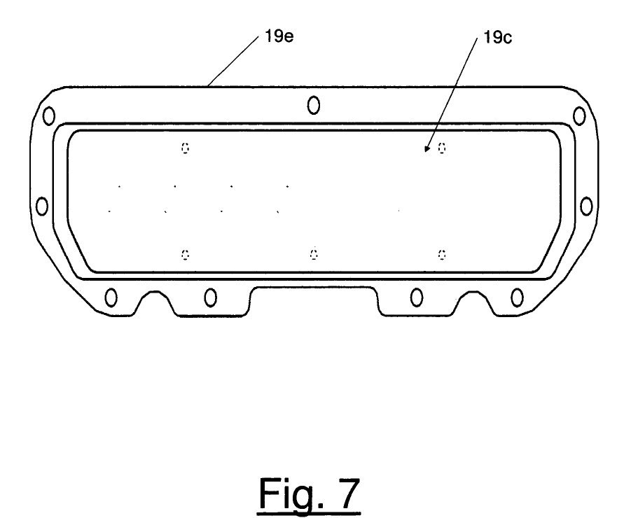

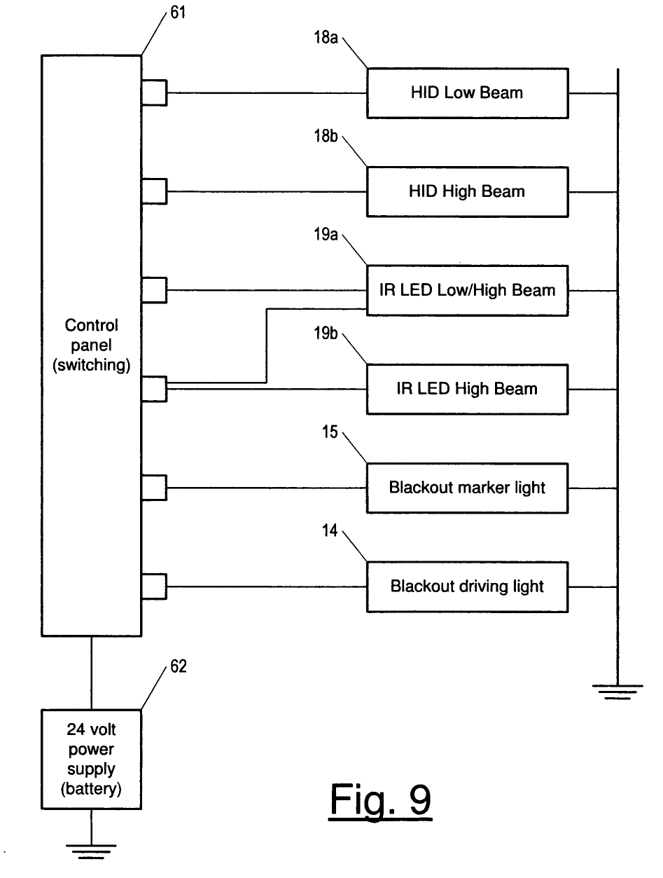

Referring now to FIGS. 1-9, the invention provides a headlamp system 12 that is interchangeable with the (composite) headlamp system 11 of the prior art. The headlamp system 12 comprises a housing front component 12b covering and affixed to a back component 12a, the front component 12b having two slots, a first slot into which a low beam HID light 18a is inserted, and a second slot into which a high beam HID light 18b is inserted. An LED blackout driving light 14 is centered above the low and high beam HID lights 18a 18b and located just below a hood 14a.

The HID lights 18a 18b differ principally in the reflector lens component. The high beam HID light has a reflector component that provides a more collimated beam. In an advantageous embodiment, the HID lights used in the headlamp system 12 have an average luminescence of 200,000 cd (candela), and a color temperature of 5000 K (similar to daylight).

Ballasts 18d 18e are affixed to the interior of the housing back component 12a at a plurality of supports 12d, and fit into a cut out or recessed area 12c carved out of the interior of the metal housing component 12a, allowing the ballasts 18d 18e to fit further back into the housing. A metal plate 18f, typically made of aluminum, is affixed over the ballasts 18d 18e and attached to the back housing component at the plurality of supports 12d. The plate 18f has two holes to accommodate electrical wiring from the HID lights 18a 18b. A main printed circuit board 18c is affixed to the center of the plate 18f and mechanically supports and electrically connects the lighting components 14 15 18a 18b 18d 18e 19a 19b 19g to electrical contacts within a base 20. The back component 12a includes a centralized hole located beneath the ballasts and the main printed circuit board through which all wiring for the lighting components exit the housing and enter the base 20. The base 20 contains electrical contacts as well as a nut, serving as both a physical connector to connect the headlamp system 12 to a vehicle, as well as an electrical connector, electrically connecting the headlamp's lighting components to a vehicle's control panel 61 and a power supply 62.

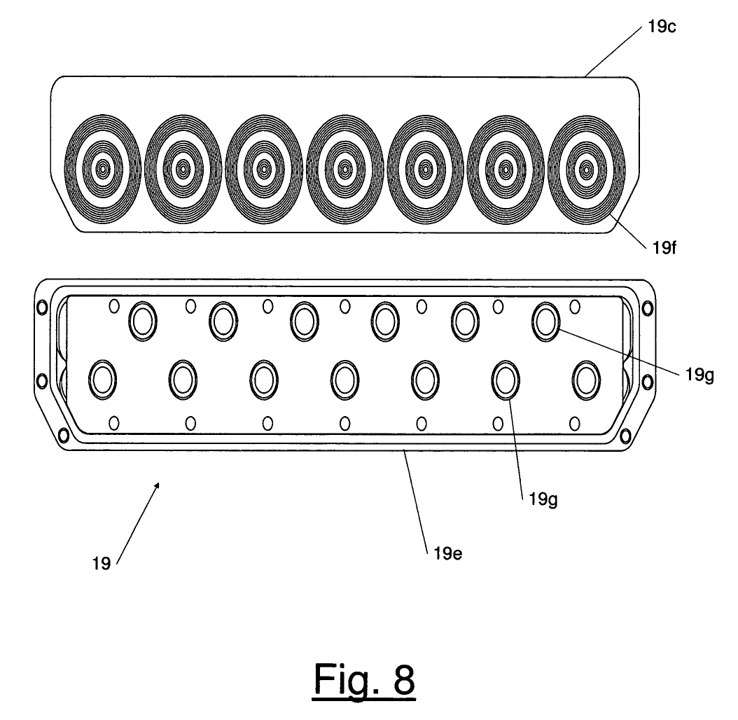

Located below the HID lights 18a 18b in the housing front component 12b is an IR illuminator 19. Referring more specifically to FIG. 8, the illuminator comprises a housing 19e, for holding an array of IR LEDs 19g on a printed circuit board (not shown), and in an embodiment shown more particularly in FIG. 8, includes six IR LEDs 19g in a first row and seven IR LEDs 19g in a second row. The type of IR LED suitable for use in this embodiment has an integrated lens. In such an embodiment, for low beam operation only the IR LEDs 19g in the first row are turned on, but for high beam operation all of the IR LEDs are turned on. The array of IR LEDs is covered by a cover 19c made of plastic or glass that may or may not filter out visible light. The cover may or may not include a Fresnel lens 19f at locations corresponding to those of the IR LEDs 19g used only for high (IR) beam operation.

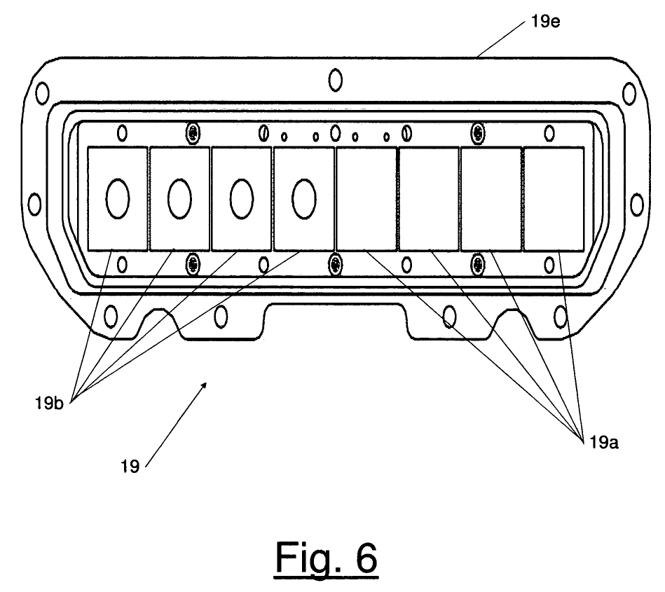

In other embodiments, such as the embodiment shown in FIG. 6, a combined IR LED-lens unit may be used. The type of IR LED suitable for use in this embodiment lacks an integrated lens, and a separate lens is added to each IR LED to create a combined IR LED-lens unit. Four low beam IR LED-lens units 19a are located on one side of the printed circuit board, in this embodiment, shown on the right side of the headlamp. Each low beam unit 19a features a dispersion lens for low beam operation. Four high beam IR LED-lens units 19b are located on the opposite side of the printed circuit board, in this embodiment, shown on the left side of the headlamp. Each high beam unit 19b features a spot lens. High beam operation is achieved by simultaneously turning on all the units 19a 19b. The housing 19e is typically made from aluminum, to facilitate conducting LED-generated heat away from those LED units 19a 19b, to the headlamp housing 12a 12b.

The IR LEDs 19a 19b 19g may have a spectrum substantially centered about one or another wavelength in the infrared. In a typical embodiment, the center wavelength is 880 nm, but higher wavelengths are also used, including 940 nm. The higher wavelength may have the disadvantage of producing less IR illumination per Watt of power consumed, but typically produces no visible light whatsoever, whereas IR LEDs at 880 nm may produce some (reddish) light at the far end of the visible spectrum. In case of using IR LEDs at 940 nm, a headlamp system according to the invention may use an array of more LEDs, even up to three times the number of LEDs shown in FIG. 8, and the LEDs may be provided in an array other than one consisting of two rows. For example, an octagonal array may be used. In embodiments using combined LED-lens units, as that illustrated in FIG. 6, the units are arranged so that all the high beam IR LED-lens units are located on one side, and all the low beam IR LED-lens units are located on the other side.

Below the IR illuminator 19 is an LED blackout marker light 15.

The headlamp system 12 of the invention has the same form and fit, mounting location, and hardware as the prior art headlamp system 11, uses the prior art vehicle wiring harness, and is installable by field service technicians in place of the prior art headlamp system. The headlamp system 12 uses the vehicle's existing switch configuration and wiring harness, illustrated schematically as including the control panel 61 for switching on and off power from the typically 24 v power supply 62, to different ones of the IR and visible illuminators, and also to the blackout marker light 15 and the blackout driving light 14.

IR LEDs suitable for use in the embodiment of the invention shown in FIG. 8 feature an integrated lens, such as the 880 nm peak IR LED with part number OD-50L from Opto-Diode of Newberry Park, Calif., and the 940 nm peak IR LED with part number OD-50L-940 also from Opto-Diode. IR LEDs suitable for use in the embodiment of the invention shown in FIG. 6 lack an integrated lens, such as the 940 nm peak IR LED with part number SFH4231 from OSRAM of Munich, Germany. Spot and dispersion lenses suitable for use in the embodiment of the invention shown in FIG. 6 are available from Ledil OY of Salo, Finland, the spot lens using part number OSS-RS, and the dispersion lens using part number OSS-O.

The HID lights used in headlamp system according to the invention are a 35 watt Xenon System available from Ibis Tek, LLC of Butler, Pa., the high beam HID light using part number 9-00002213, and the low beam HID light using part number 9-00002214. Ballasts 18d 18e for these lights are also available from Ibis Tek, LLC using part number HID 24 v 9-00002216.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A headlamp system (12), comprising:
a housing back component (12a) and a front component (12b), the front component affixed to the back component, the front component having slots into which a low beam HID light (18a) is inserted, a high beam HID light (18b) is inserted, and an infrared illuminator (19) is inserted;
ballasts (18d 18e) affixed to the interior of the back component (12a) and electrically connected to the HID lights (18a 18b);
a printed circuit board (18c) electrically connecting the lighting components; and
a base (20) affixed to the housing back component, having a nut and a plurality of electrical connections allowing the headlamp system (12) to be physically connected to a vehicle and electrically connected to the vehicle's control panel (61) and power supply (62).

2. The headlamp system (12) of claim 1, wherein the infrared illuminator (19) comprises a housing (19e) enclosed by a cover (19c), the housing containing an array of infrared light emitting diodes, at least one infrared light emitting diode providing low beam operation and at least one infrared light emitting diode providing high beam operation.

3. The headlamp system (12) of claim 2, wherein the array of infrared light emitting diodes used are combined light-emitting diode-lens units (19a 19b).

4. The headlamp system (12) of claim 2, wherein the infrared illuminator housing (19e) is made of aluminum.

5. The headlamp system (12) of claim 1, further comprising a blackout driving light (14) with a hood (14a) located above the low and high beam HID lights and a blackout marker light (15) located below the infrared illuminator (19).

6. The headlamp system (12) of claim 1, wherein the blackout driving light (14) and the blackout marker light (15) use light emitting diodes as light sources.

7. The headlamp system (12) of claim 1, wherein the headlamp housing has the same form and fit, mounting location, hardware, and is interchangeable with the headlamp system of the prior art (11).
